(19) United States
(12) Patent Application Publication
(10) Pub. No.: US 2022/0164309 A1
(43) Pub. Date: May 26, 2022

(54) SYSTEMS AND METHODS FOR DEALERSHIPS FOR OPTIMIZING CUSTOMER FINANCING OPTIONS

(71) Applicant: E-Director LLC, Burlington, WA (US)

(72) Inventors: Nate Doggett, Whitefish, MT (US); Brett M. Davis, McKinney, TX (US)

(21) Appl. No.: 17/532,837

(22) Filed: Nov. 22, 2021

Related U.S. Application Data
(60) Provisional application No. 63/116,241, filed on Nov. 20, 2020.

(51) Int. Cl. G06F 16/11

(52) U.S. Cl. CPC G06F 16/122

(57) ABSTRACT

A method of providing a deal optimization web service for dealerships includes receiving rate sheets from subscriber dealerships, the rate sheets containing parameters and parameter data for at least some of parameters that define a new deal, mapping the parameters into fields of a database, formatting the data for storage in the database, and storing the updated database. A system has a server having at least one processor, a display device, and a local memory, the server connected to a network, a database connected to the server, and a network of dealerships connected to the server through the network, wherein the at least one processor is configured to execute code that causes the at least one processor to render a user interface on the display device that allows an administrative user to enter data into the database in a pre-defined format, the pre-defined format configured standardize and configure the data in the database for efficient searching by end-users.

### CROSS REFERENCE TO RELATED APPLICATION

This application claims priority to and the benefit of U.S. Provisional Patent Application No. 63/116,241 filed Nov. 20, 2020, which is incorporated by reference in its entirety.

### TECHNICAL FIELD

This disclosure is directed to systems and methods for enabling various dealerships, e.g., automobiles, recreational vehicles (RVs), boats, and motor sports, to optimize customer financing options for purchases.

### BACKGROUND

In the lending business, lenders usually use different criteria for determining the rate and term for each loan. While some lenders may use credit bureaus such as Experian, other lenders may use other bureaus such as Equifax or Transunion. Some lenders will use the highest score from all of the credit bureaus, or they may choose to use the highest score from two of the scores. It should be noted that a customer's credit score can vary by as much as 100 points between each of these bureaus.

Lenders often use a variety of criteria for the loan to value of each loan. While some lenders may use the invoice price on new cars, others will use the manufacturer's suggested retail price (MSRP) for the car. The same can be said for used cars, where there is NADA retail or wholesale, as well as Kelly Blue Book (KBB) retail or wholesale. Some lenders will use either KBB or NADA retail, whichever is higher, and some choose to use NADA retail or KBB wholesale. It is not unusual for the difference between KBB and NADA to be thousands of dollars.

It should be noted that many Credit Unions will only lend based on the county in which the customer resides.

A dealership in a major metropolitan market may have hundreds of lenders available. With all of the different variables and criteria between lenders, it is extremely challenging if not impossible to memorize the rate sheets for each lender that a dealership may do business with.

There remains a need for improved systems and methods for enabling various dealerships to optimize customer financing options.

### BRIEF DESCRIPTION OF THE DRAWINGS

FIG. 1 shows an embodiment of a system that includes a platform and database for tracking lenders and deal terms to be offered to dealerships.

FIG. 2 shows a flowchart of an embodiment of a method of gathering data in a search-efficient manner for databases.

FIG. 3 shows a flowchart of an embodiment of an automated method to parse rate sheets.

FIG. 4 shows a flowchart of an embodiment of a method to provide search capabilities to an end user.

FIGS. 5-7 show portions of an embodiment of a user interface provided to an administrative user for a platform.

FIG. 8 shows an embodiment of dealer use report.

FIG. 9 shows an embodiment of a search interface for a dealer user.

FIG. 10 shows an embodiment of a lender performance report.

FIG. 11 shows an embodiment of a pending performance report.

FIG. 12 shows an embodiment of sort options for sorting qualifying lenders for a particular search.

FIG. 13 shows an embodiment of a user interface for an end user.

### DETAILED DESCRIPTION

Implementations of the disclosed technology, which may also be referred to herein as “e-Director,” generally include an innovative platform that includes a web-based proprietary lender management program designed to assist automobile, RV, marine and power sport dealerships in obtaining the best financing rates and terms for customers while maximizing front-end and back-end gross profits for the selling dealer.

As used here, the term “dealership” means dealers of automobiles, recreational vehicles (RVs), boats, motor sports, etc. Similarly, as used here, the term “lender” means any institution that lends money to purchasers buying from dealerships. The lenders generate “deal sheets,” or “rate sheets,” meaning the parameters of a particular loan. Rate sheets have several possible parameters, some or all of which may be included in a particular loan or “deal.” This include, but are not limited to: customer name; zip code; one or more credit scores; status as a buyer, such as first-time; sales price; tax, title and license (TTL); rebate; trade equity; add-ons; co-signer details; manufacture suggested retail price (MSRP); invoice amount; National Automobile Dealers Association (NADA) information; Kelley Blue Book (KBB) information; service contract amount; maintenance; guaranteed asset protection (GAP) insurance; sell rate; vehicle information including year, miles and term; and cash down.

That platform generally involves a data-driven solution that can quickly and easily compile, sort and compare lending information. This advantageously saves valuable time, increases deal approvals, and maximize profits. The solution also enables standardization of information across many different platforms and lender systems to allow creation and maintenance of a database that provides users, lenders, and dealerships with the ability to access the database and sort it efficiently to access the data needed.

Implementations of the disclosed technology allows the platform to gather and store all of the lender rate sheet data for a particular dealership in a database, and efficiently sort all of the information based on any of the parameters of the rate sheets. The system will also have the rate sheets for multiple lenders. Once the platform receives the customer information and deal information, the platform can generate a report that indicates which lender will give the customer the best rate and term based on the information entered. The platform can also inform the dealership as to which lender will give the biggest advance, reserve, meaning the profit from loan, backend products, and final payment for customers, and can track the performance and statistics for lenders and dealerships to monitor their use of the system and their qualifications for various deals.

The disclosed platform may advantageously identify which lenders the customer may qualify for based upon the customer's qualification, such as county of residence, or other qualifying factors for a particular credit union or lender, such as military service or affiliation with an organization.

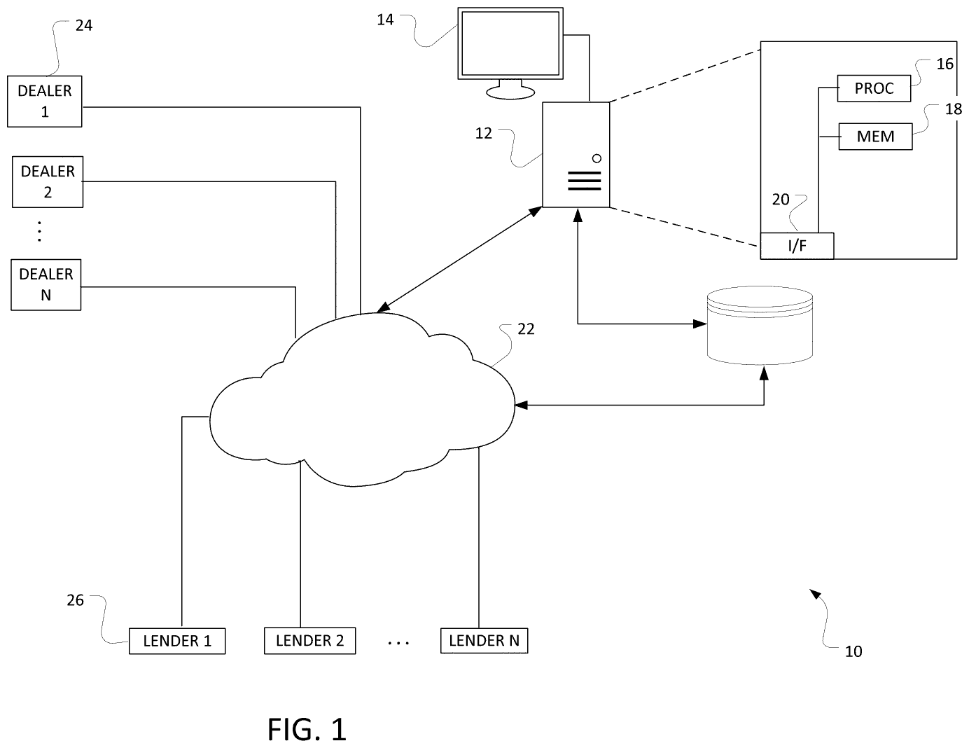

FIG. 1 shows an embodiment of a system 10 including a platform for enabling various dealerships to optimize customer financing options for purchases in accordance with certain implementations of the disclosed technology. The platform will typically take the form of a web services application that operates on one or more servers, such as 12, where the term “server” means any computing device configured to run applications, rather than to work as a user device. The server 12 will typically have one or more processors such as 16, a memory located on the server computing device referred to as a ‘local’ memory, and a network interface 20.

An administrative user, meaning someone who interacts with the application directly to input data and perform any maintenance or other work on the server or application, will typically interact with the application through a user input/output device, such as display 14. Display 14 may connect directly to the server, or the display 14 may connect to another computing device that operates on the server. The device through which the administrative user interacts with the application server may also connect to the application through the network 22.

The server will have one or more network interfaces such as 20 that allow the server to officer the application through the network to different types of users. The one or more interfaces may comprise a wireless (WiFi) link, a near-field communication link, a dial-up connection, an Ethernet connection, etc. For the purposes of this discussion, three different types of users may interact with the application. The administrative user is discussed above. The dealership user will typically be a user from a dealership such as 24, usually in the finance department of a dealership, using the platform to acquire information on available financing of the vehicle being purchased. An end user is a vehicle purchaser who may access the application as a means to locate a lender from whom they want to take a loan to finance the purchase.

The platform has connections across the network 22 to subscriber dealerships such as 24. The dealerships purchase a license to the platform and can use it to locate loans and lenders for their customers. The dealerships will more than likely have some sort of connection to the lending institutions such as 26, either through the same network 22 such as the Internet, or just by phone or personal contacts. In most scenarios, the lending institutions will not use the platform, although that is also possible.

When a dealership sets up a new loan for a vehicle purchase, they may send the information to the platform for entry into the database. The entry into the database will be discussed in more detail further. Alternatively, the subscriber may provide the platform with access to CUDL, a network of credit unions that finance vehicle purchase at dealerships, RouteOne a vehicle financing network for dealers and lenders, or DealerTrack, an automotive dealership management solution, as examples, as a means to gather rate sheets.

The administrative user takes the rate sheets, in whatever format they exist, and gathers the deal parameters used, which may or may not include all of the parameters mentioned above. The parameter is the particular element such as those mentioned above, and the parameter data is the value of that parameter. As an example, the parameter may be “first time buyer” and the data is “yes” or “no,” where that data may be gathered as a check box.

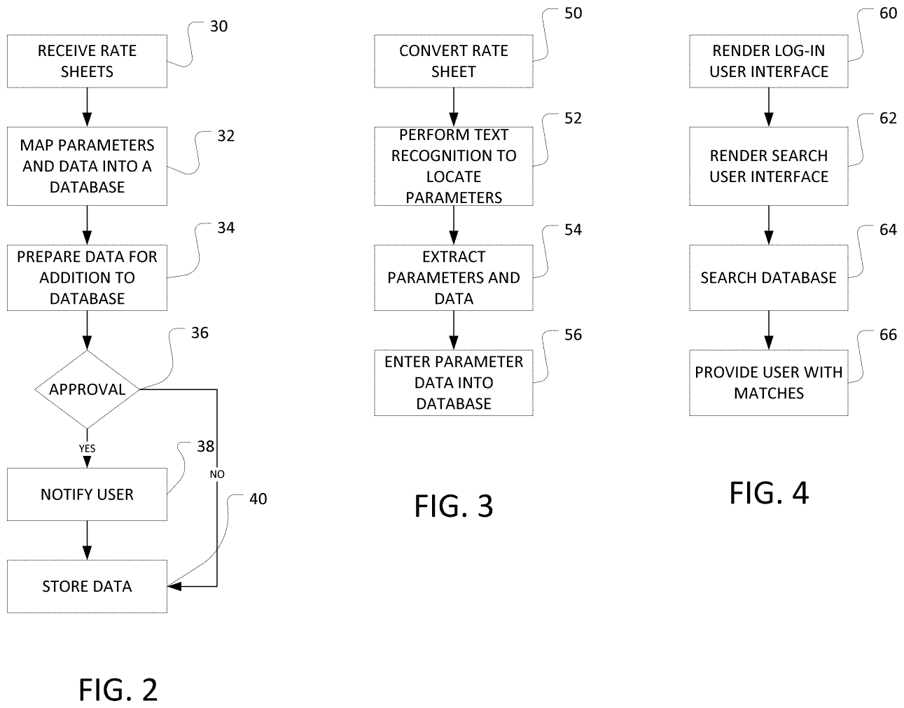

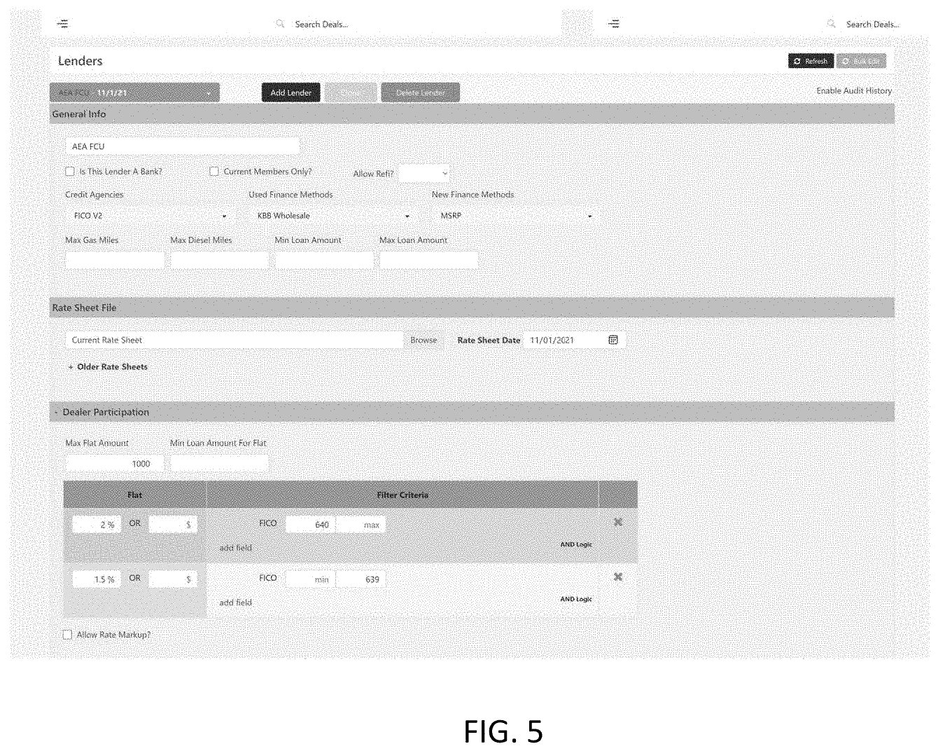

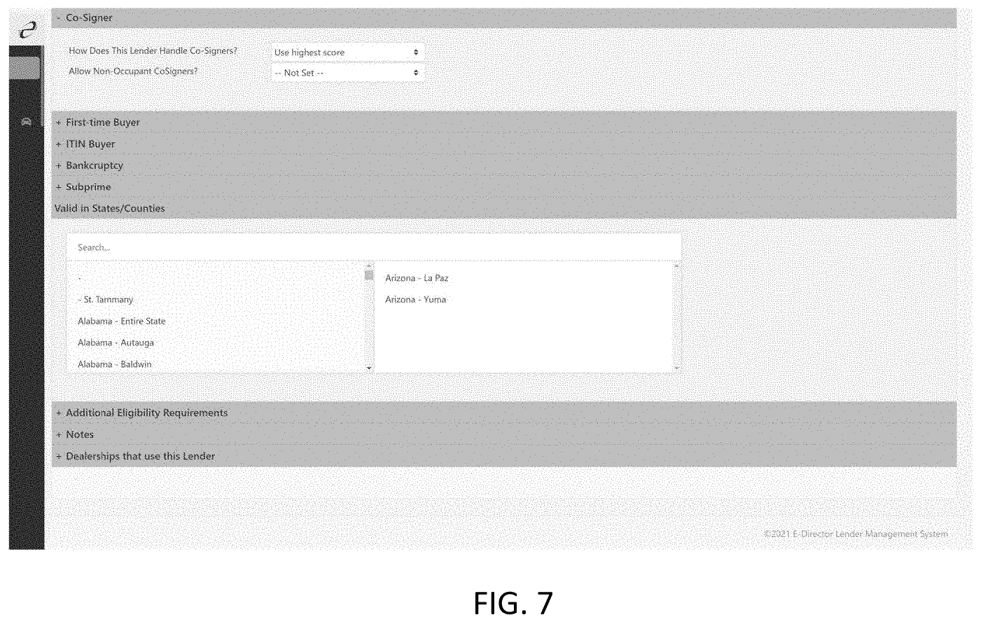

FIG. 2 shows a flowchart of a method of gathering the disparate rate sheet data and storing it into a database. The database has an entry system that allows for a much more efficient gathering and storing of the various parameters and their associated data to allow for more efficient searching for users. The rate sheets are gathered at 30. The rate sheet parameters and their associated data is mapped into the database at 32, and will be discussed in more detail with regard to FIG. 3, and FIGS. 5-7. The data is then set up to be entered into the database at 34. In some instances there may be an approval of the data for a particular deal needed prior to the data being stored in the database at 36. For example, the deal sheet may be from a new lender that was not previously in the database, and the system may have a flag configured to ensure the deal and that lender were approved prior to being entered. In other situations, there may be certain parameters that have data outside of a desired range that requires override or approval. If approval is needed at 36, the administrative user is notified at 38 and when approved the new data is stored in the database at 40. If no approval is needed at 36, the data is just stored. If approval is needed and not given, the data is not stored.

The mapping of the parameters and associated data into the database may occur in one of two ways. In one embodiment, discussed with regard to FIG. 3, an automatic parser is used to access the rate sheets and ‘convert’ them to the necessary data for the database. In one embodiment, the parser converts the rate sheet into an editable or accessible document that allows the parser to perform text recognition on the text of the document, such as an editable PDF, Word document, etc. The parser then performs text recognition to locate the parameters wherever they exist in the rate sheet at 52, and extracts the associated data for the parameters at 54. This data is then entered into the desired format of the database.

In another embodiment, the administrator user enters the data through a user interface that is formatted to allow the most efficient searching of the various parameters and data. FIGS. 5-7 show an embodiment of this user interface. The user interface has been broken up into three pieces for ease of viewing, but will typically be rendered on a display device as one ‘screen’ or user interface. FIG. 5 would be the top of the example, FIG. 6 would be the middle, and FIG. 7 would be the bottom, but no limitation to any configuration of the elements is intended, nor should any be implied. The formatting of what parameters are to be used is an important aspect. The term “user interface” here may be a short hand way of saying “graphical user interface” or GUI.

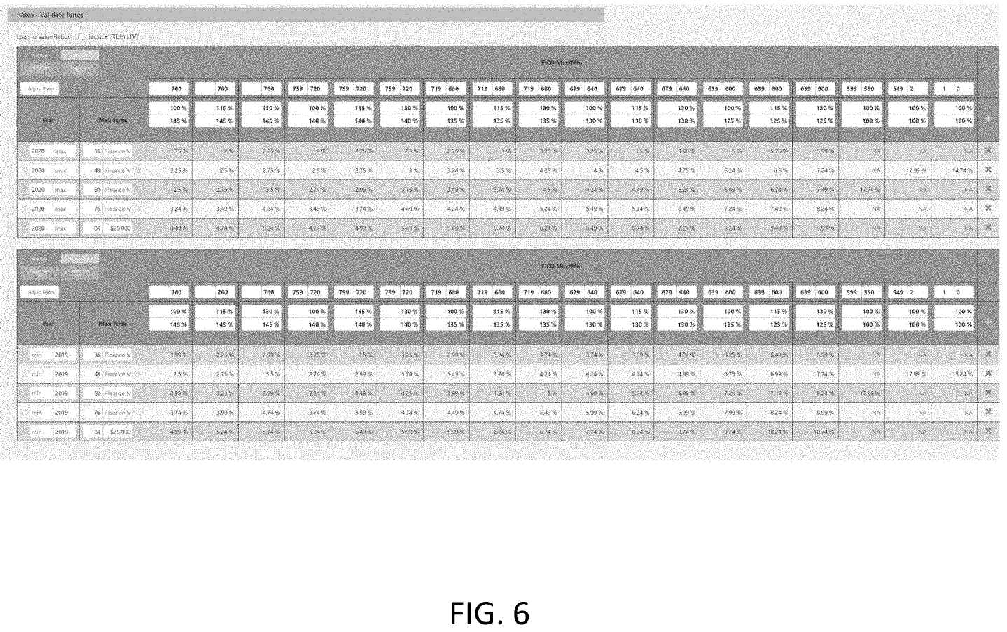

FIG. 4 shows the process that would be used for either a dealership user or an end user/customer. The user logs in through a log in user interface at 60, makes their selections on the search user interface at 62, the search is performed at 64 and the user sees the matching lenders/offers at 66. However, the existence of the database provides many different metrics and information that can be gathered, beyond just locating optimal financing for a particular deal.

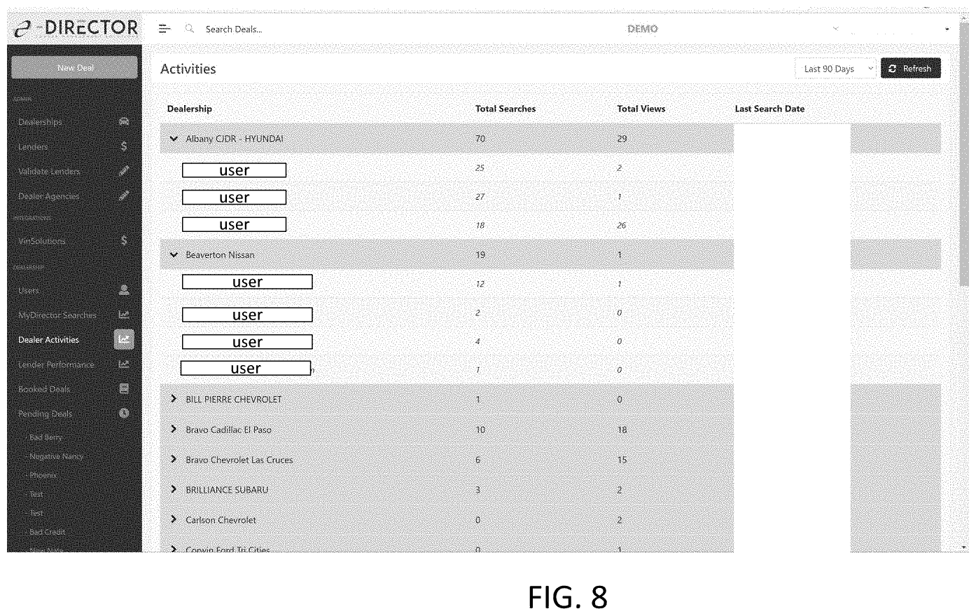

FIG. 8 shows an embodiment of a dealership activity report that tracks the searching activity for each dealer subscriber that uses the platform.

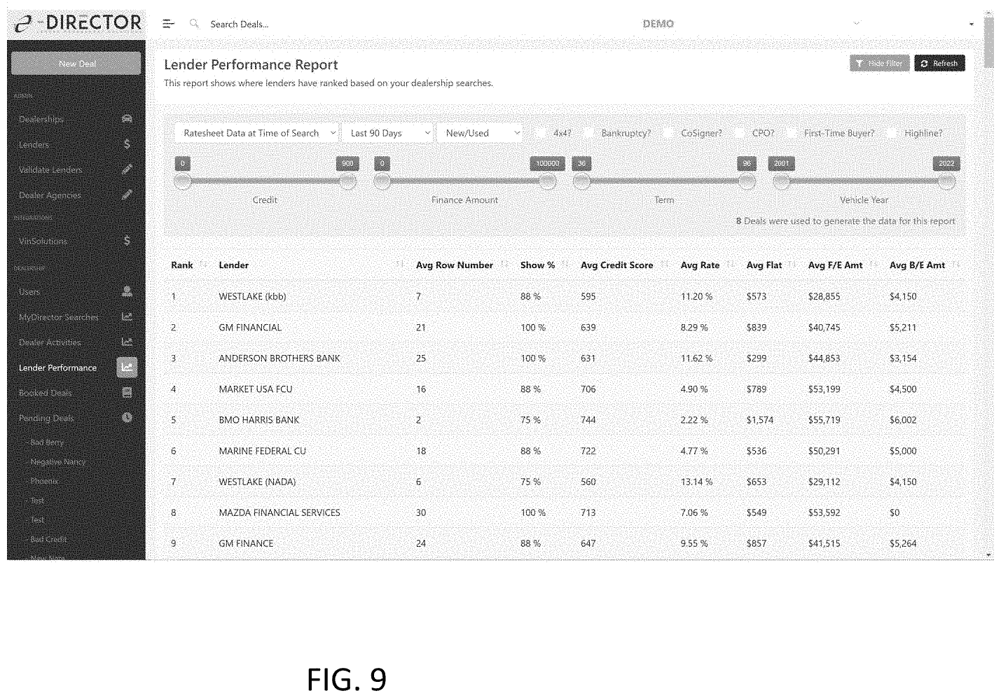

FIG. 9 shows a lender performance report that shows some metrics for the various lenders that exist in the database.

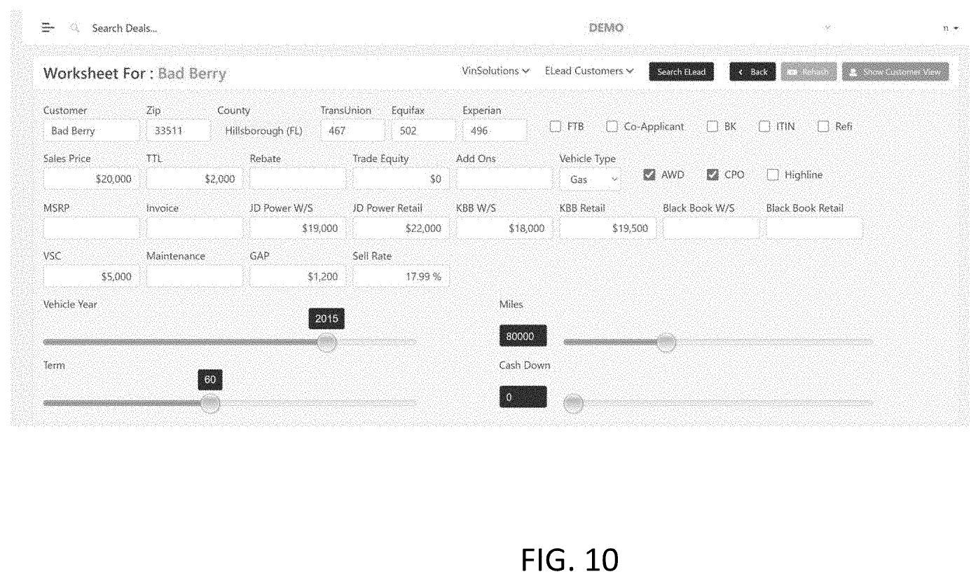

FIG. 10 shows an interface for the dealership user to enter the search parameters desired. As one can see, not all of the search fields need to be entered.

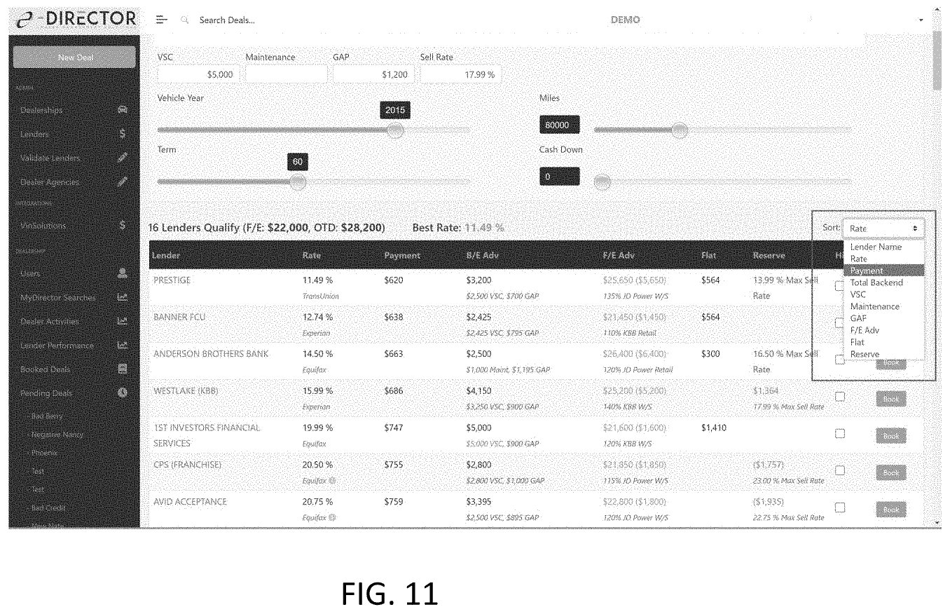

FIG. 11 shows a results page for a search. The results page shows the search at the top and the qualifying lenders below. The page also shows that availability of different sorting parameters that allow the dealership user to sort the qualifying offers. While not shown, the search results page may also show those lenders that did not qualify with any deals that were within the parameters of the current search.

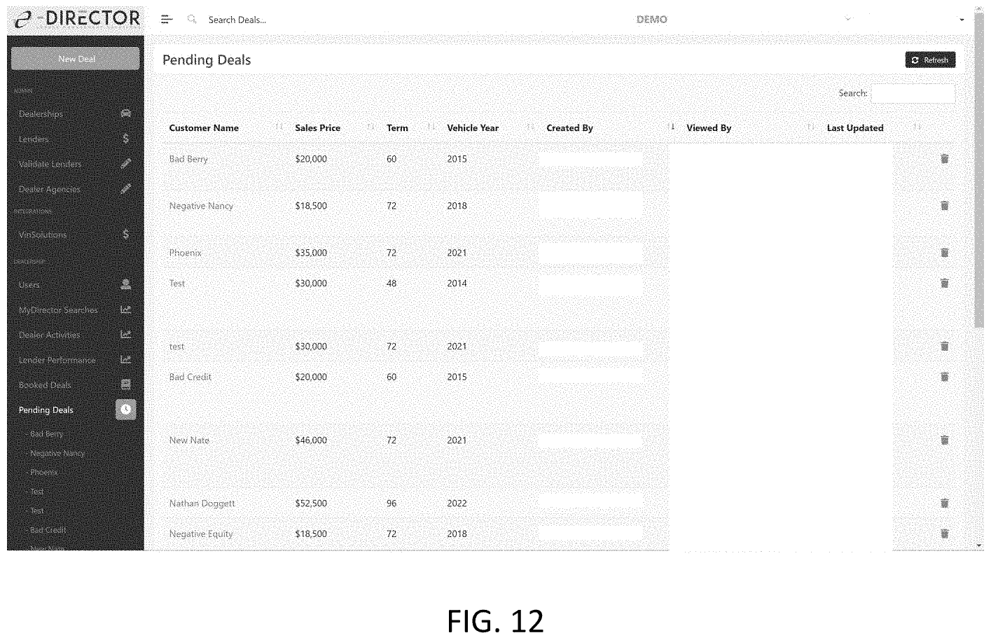

FIG. 12 shows a list of pending deals in the system, so the user can look the pending deals and update or close them as necessary.

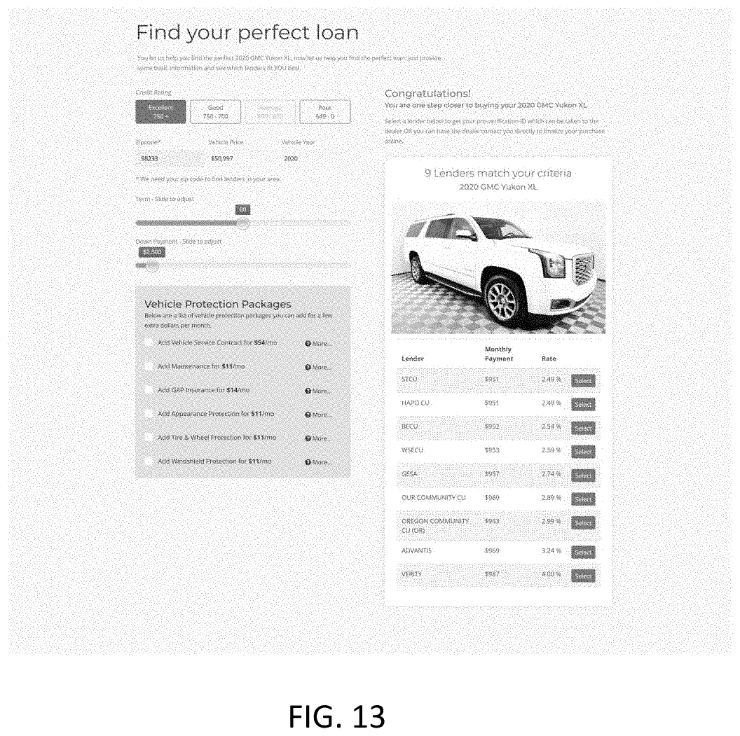

Up until this point in the discussion, the user interfaces have been for the administrator or dealership users. FIG. 13 shows an example of a user interface for an end user. This may be presented to the end user at a kiosk in a subscribing dealership, or access may be given the end user by the dealership when the end user is working with that dealership, etc. The database may not be limited strictly to dealership users.

The disclosed platform may advantageously speed up the finance process, positively enhancing the customer experience. The disclosed platform may advantageously maximize a dealership's front-end profit on every deal based on the loan to value that is allowed by each lender. The disclosed platform may also advantageously allow dealerships to sell more backend products by clearly listing the maximum allowable sales price per product. Further, with the disclosed platform, high-mileage and older vehicles are no longer a guessing game as to who will buy them.

The disclosed platform may advantageously allow direct links to lender rate sheets, thus obviating any need for outdated bank books. The disclosed platform may advantageously identify the lowest rate that is available to each customer based on their credit and the available lenders. The disclosed platform may also advantageously determine the maximum loan length on every deal.

The disclosed platform may advantageously result in enhanced customer satisfaction by providing a transparent experience for the customer. In certain implementations, a first-time buyer option can clearly identify which lenders have programs suitable for first-time buyers.

The disclosed platform may advantageously convert more outside finance and cash deals to in-house finance deals. There may be fewer charge backs due to refinancing at lower rates. The disclosed platform may also advantageously minimize errors, result in fewer re-signs, and shorter contract in transit times.

The disclosed platform may advantageously determine with great accuracy dealer flats, rate reserve, or rate buydown for every lender. Implementations of the disclosed platform may be advantageously customizable for each dealership based on the lenders that they have dealer agreements with, for example. The disclosed platform may also advantageously expedite the learning process for new Finance Managers and/or Desk Managers. Implementations of the disclosed technology may advantageously identify special financing, e.g., for credit-challenged customers.

It will be appreciated that, in situations where a single deal is approved that otherwise wouldn't have without the disclosed platform, or if the platform finds a lender who will give 130% of NADA retail for a customer who is rolling negative equity into a loan, or if the platform identifies a lender who will give a 2% flat on the amount financed vs 1.5%, then the disclosed platform will have already paid for itself.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers.

One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGAs, and the like.

Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or computer-readable storage media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

1. A computer-implemented method of providing a deal optimization web service for dealerships, comprising:
receiving rate sheets from subscriber dealerships, the rate sheets containing parameters and parameter data for at least some of parameters that define a new deal;
mapping the parameters into fields of a database;
formatting the data for storage in the database; and
storing the updated database.

2. The computer-implemented method as claimed in claim 1, wherein receiving the rate sheets comprises access to one or more financing platforms used by dealers.

3. The computer-implemented method as claimed in claim 1, wherein receiving the rate sheets comprises receiving a document containing multiple rate sheets.

4. The computer-implemented method as claimed in claim 1, wherein the mapping of parameters into the fields of the database comprises using an automated parser, the automated parser comprises computer code that when executed by a processor causes the processor to:
convert the rate sheet into an editable document;
performing text recognition on the editable document to locate parameters that match the fields in the database;
extracting the parameters and the parameter data for the matching parameters; and
entering the parameter into appropriate fields in the database.

5. The computer-implemented method as claimed in claim 1, wherein the mapping of the parameters into the fields of the database comprises providing an administrative user with a graphical user interface formatted to allow the administrative user to enter parameter data for the parameters of the deal into the database in a pre-defined format, the pre-defined format to ensure efficient searching of the database by end users.

6. The computer-implemented method as claimed in claim 1, wherein the parameters include at least one selected from the group consisting of: customer name, customer zip code, customer credit score, whether the customer is a first-time buyer, vehicle sale price, TTL, rebate status, trade equity, at least one add-on, co-signer details, whether the vehicle has four-wheel drive, vehicle MSRP, vehicle invoice price, NADA information, KBB information, service contract amount, maintenance, GAP, vehicle sell rate, vehicle make, vehicle model, vehicle year, vehicle mileage, vehicle term, and amount of cash down.

7. The computer-implemented method of claim 1, further comprising notifying an administrative user of a need for approval of a new parsed sheet.

8. The computer-implemented method of claim 7, further comprising, responsive to the administrative user deciding to approve the at least one parsed sheet and the lender being an existing lender, updating the existing lender with the latest rates in the database.

9. The computer-implemented method of claim 7, further comprising, responsive to the administrative user deciding to approve the at least one parsed sheet and the lender being a new lender, creating a new lender in the database.

10. A computer-implemented method to enable a dealership to optimize customer financing options for a purchase, the method comprising:
providing a log-in user interface to an end user at the dealership logging into a website application service;
rendering a search user interface for the end-user to allow the end-user to provide a plurality of search criteria to the website application service;
the website application service accessing a database and searching the database using the search criteria; and
the website application service providing to the end user at the dealership at least one result that matches the provided search criteria.

11. The computer-implemented method of claim 10, wherein the purchase includes at least one selected from the group consisting of the following: automobiles, recreational vehicles (RVs), boats, and motor sport vehicles.

12. The computer-implemented method of claim 10, wherein the plurality of search criteria includes at least one selected from the group consisting of the following: customer name, customer zip code, customer credit score, whether the customer is a first-time buyer, vehicle sale price, TTL, rebate status, trade equity, at least one add-on, co-signer details, whether the vehicle has four-wheel drive, vehicle MSRP, vehicle invoice price, NADA information, KBB information, service contract amount, maintenance, GAP, vehicle sell rate, vehicle make, vehicle model, vehicle year, vehicle mileage, vehicle term, and amount of cash down.

13. The computer-implemented method of claim 12, wherein the customer credit score includes a result from at least one credit bureau.

14. The computer-implemented method of claim 10, further comprising allowing the end user to at least one of sort and filter the at least one result to select an optimal option for the customer.

15. A system, comprising:
a server having at least one processor, a display device, and a local memory, the server connected to a network;
a database connected to the server; and
a network of dealerships connected to the server through the network,
wherein the at least one processor is configured to execute code that causes the at least one processor to render a user interface on the display device that allows an administrative user to enter data into the database in a pre-defined format, the pre-defined format configured standardize and configure the data in the database for efficient searching by end-users.
